(19) United States
(12) Patent Application Publication
(10) Pub. No.: US 2008/0017468 A1
(43) Pub. Date: Jan. 24, 2008

(54) DRIVE MEMBER FOR WATER PUMP

(75) Inventors: Rainer KRAFFT, Heiligenberg (DE); Andreas Wolf, Tettnang (DE)

Correspondence Address: BURR & BROWN, PO BOX 7068, SYRACUSE, NY, 13261-7068, US

(73) Assignee: Linnig Trucktec GmbH, Markdorf (DE)

(21) Appl. No.: 11/780,143

(22) Filed: Jul. 19, 2007

(30) Foreign Application Priority Data
Jul. 21, 2006 (DE) 10 2006 034 308.5

(51) Int. Cl. F16D 27/112; F16D 27/12

(52) U.S. Cl. 192/40

(57) ABSTRACT

A drive member for a water pump of a cooling water circuit of an internal combustion engine, including a drive wheel, a shaft which is coupled to the water pump, and an electromagnetically actuable frictional shift clutch for the transfer of torque between the drive wheel and the shaft. According to the invention, a transfer of torque to a driven wheel can be shifted by means of the frictional shift clutch.

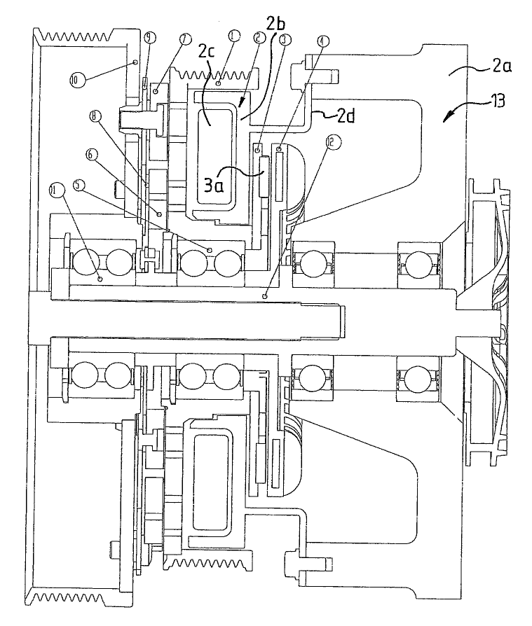

This application claims the benefit under 35 USC §119(a)-(d) of German Application No. 10 2006 034 308.5, filed Jul. 21, 2006, the entirety of which is incorporated herein by reference.

### FIELD OF THE INVENTION

The invention relates to a drive member for a water pump.

### BACKGROUND OF THE INVENTION

German Laid-Open Patent Publication No. DE 101 58 732 A1 discloses a drive member for a water pump of the cooling water circuit of an internal combustion engine.

The drive member comprises a drive wheel and a shaft which is coupled to the water pump. To transfer the torque between the drive wheel and shaft, an electromagnetically actuable frictional shift clutch is provided, and also a second clutch device in the form of an eddy current clutch which takes up the shaft when the frictional shift clutch is out of engagement.

This already makes it possible to have an effective drive of a cooling water pump in internal combustion engines.

### SUMMARY OF THE INVENTION

The object on which the invention is based is to design a drive member of the type initially designated, such that the field of use is broadened.

The invention proceeds from a drive member for a water pump of the cooling water circuit of an internal combustion engine, with a drive wheel, with a shaft which is coupled to the water pump, and with an electromagnetically actuable frictional shift clutch for the transfer of torque between the drive wheel and the shaft. The essence of the invention is that a transfer of torque to a driven wheel can be shifted by means of the frictional shift clutch. For example, the drive wheel is a belt pulley which is driven by the engine.

The driven wheel is preferably likewise a belt pulley, via which, for example, a fan wheel can be driven by means of a corresponding belt.

It is consequently possible, for example, to cut in a fan wheel via the driven wheel, in that the driven wheel is cut in via the frictional shift clutch, without a further clutch unit being required.

Preferably, the drive wheel is mounted on the shaft, for example via a rolling bearing. It is likewise preferred if the driven wheel, too, is permanently mounted in a corresponding way on the shaft at the water pump. A compact type of construction can thereby be implemented.

In a preferred refinement of the invention, an armature disk is arranged between the drive wheel and the driven wheel. The armature disk is preferably divided radially. A first part of the armature disk is advantageously connected permanently to the shaft, whereas, preferably, the second part of the armature disk is connected permanently to the driven wheel, for example via a spring. Furthermore, it is advantageous if the frictional shift clutch comprises two electromagnets which are separately switchable. By means of a first electromagnet, for example, that part of the armature disk which is connected fixedly in terms of rotation to the driven wheel can be pulled up to the drive wheel, with the result that the driven wheel can be driven at the same rotational speed as the first drive wheel.

Via the second electromagnet, the first part of the armature disk can be connected to the drive wheel, with the result that the shaft of the water pump can be brought to the rotational speed of the drive wheel.

In a further advantageous refinement of the invention, however, it is also conceivable to provide only one electromagnet. In this respect, it is then preferred if an electronic unit is provided in order to operate the electromagnet in at least two field strength steps. In a first field strength step, preferably only the first part of the armature disk, which is connected to the shaft, is connected to the drive wheel. Consequently, the shaft can be brought to the same rotational speed as the drive wheel. In a second field strength step, which is preferably higher than the first field strength step, the second part of the armature disk, to which the driven wheel is connected, is brought into nonpositive contact with the drive wheel, so that the driven wheel operates at the same rotational speed as the drive wheel.

So that a water pump can be operated at a basic rotational speed, moreover, it is proposed that an eddy current clutch be provided, which takes up the shaft when the first part of the armature disk is not shifted. The frictional shift clutch is then preferably completely out of engagement. Part of the eddy current clutch may be connected permanently to the drive wheel.

For example, permanent magnets are arranged on the latter.

### BRIEF DESCRIPTION OF THE DRAWING

An exemplary embodiment of the invention is illustrated in the drawing and is explained in more detail below, with further advantages and particulars being specified. The FIGURE shows a drive member for a water pump of a cooling water circuit of an internal combustion engine in a section along the axis of rotation of a pump shaft of the cooling water pump.

### DETAILED DESCRIPTION OF THE INVENTION

The drive member consists of a preferably permanently driven rotor 1 with an integrated belt pulley, said rotor being mounted on a rolling bearing 5 of a shaft 12 of a water pump 13 (illustrated only partially). Within the radius of the rotor 1 is provided an electromagnet arrangement 2 which is supported on a housing 2a of the water pump 13 via the torque support 2d. The electromagnet arrangement 2 comprises a stator 2b in which is arranged an electromagnet 2c which can be supplied with electrical power, for example by means of a cable, from the on-board system of a vehicle (not illustrated). Fastened preferably nonpositively to the rotor 1 is a permanent magnet carrier 3 with permanent magnets 3a, opposite which stands contactlessly, via a gap, a cooling ring 4 with an embedded, for example cast-in steel ring 4a as a return element for a magnetic field which the eddy currents form. The cooling ring 4 is permanently connected to the pump shaft 12, for example via a positive/nonpositive connection. Arranged opposite the rotor 1 is a second belt pulley 10 which is likewise mounted rotatably on the pump shaft 12 via a rolling bearing 11. The belt pulley 10 drives, for example via a belt drive, a regulateable fan clutch, mounted on the crankshaft or on a separate bearing block, or, directly, a fan wheel. An armature disk 7 is fastened permanently to the belt pulley 10 via a spring 9, so that said armature disk is displaceable axially. A second armature disk 6 is connected permanently to the pump shaft 12 via a spring 8. The spring 8 likewise permits an axial movement of the armature disk 6.

Functioning of the Drive Member:

The rotor 1 with the belt pulley is driven, for example, permanently by a belt drive from a crankshaft of an internal combustion engine. Since the permanent magnet carrier is connected nonpositively to the rotor 1, it corotates permanently at the drive speed of the rotor. The magnetic field of the permanent magnets 3a generates in the cooling ring 4 eddy currents which lead to a corotation of the cooling ring 4 which, in turn, drives the pump shaft 12 and consequently the water pump at a basic rotational speed.

If, then, the electromagnet 2c is operated with an electrical power of the size P1, for example via a pulse-width-modulated signal, the armature disk 6 is pulled up. The eddy current principle between the parts 3 and 4 is consequently bridged. The pump shaft 12 is then driven permanently at the rotational drive speed of the rotor 1. In the event that the electromagnet 2c is acted upon with an electrical power P2 by a pulse-width-modulated signal, the electrical power P2 being higher than the electrical power P1, the armature disk 7 is then also pulled up in addition to the armature disk 6. This is made possible preferably in that the necessary deflection force of the spring 8 is lower than the necessary deflection force of the spring 9. This can be set, for example, via the spring rigidity of the springs 8 and 9. With the armature disk 7 pulled up, the belt pulley 10 runs at the same rotational drive speed as the rotor 1. Consequently, a fan wheel (not illustrated) can be driven at the rotational drive speed or at a rotational speed in a predetermined step-up ratio of the rotational drive speed of the rotor 1.

What is claimed:

1. A drive member for a water pump of a cooling water circuit of an internal combustion engine, comprising a drive wheel, a shaft coupled to the water pump, and an electromagnetically actuable frictional shift clutch for the transfer of torque between the drive wheel and the shaft, wherein a transfer of torque to a driven wheel can be shifted by means of the frictional shift clutch.

2. The drive member as claimed in claim 1, wherein the drive wheel is mounted on the shaft.

3. The drive member as claimed in claim 1, wherein the driven wheel is mounted on the shaft.

4. The drive member as claimed in claim 1, wherein an armature disk is arranged between the drive wheel and the driven wheel.

5. The drive member as claimed in claim 4, wherein the armature disk is divided in the radial direction.

6. The drive member as claimed in claim 4, wherein a first part of the armature disk is connected permanently to the shaft.

7. The drive member as claimed in claim 6, wherein a second part of the armature disk is connected permanently to the driven wheel.

8. The drive member as claimed in claim 1, wherein the frictional shift clutch comprises two electromagnets which are separately switchable.

9. The drive member as claimed in claim 1, wherein the frictional shift clutch comprises only one electromagnet.

10. The drive member as claimed in claim 1, wherein an electronic unit is provided in order to operate an electromagnet of the frictional shift clutch in at least two field strength steps.

11. The drive member as claimed in claim 1, wherein an eddy current clutch is provided, which takes up the shaft when the first part of the armature disk is not shifted.
